(19) United States
(12) Patent Application Publication
(10) Pub. No.: US 2015/0356479 A1
(43) Pub. Date: Dec. 10, 2015

(54) ANALYTIC FRAMEWORK FOR HANDLING TRADE-OFFS BETWEEN DIFFERENT BUSINESS OBJECTIVES IN PLANNING AND SCHEDULING APPLICATIONS

(71) Applicant: Honeywell International Inc., Morristown, NJ (US)

(72) Inventors: Lingathurai Palanisamy, Karnataka (IN); Sunkara Mahendra babu Gokul, Karnataka (IN)

(21) Appl. No.: 14/298,797

(22) Filed: Jun. 6, 2014

(51) Int. Cl. G06Q 10/06

(52) U.S. Cl. CPC G06Q 10/0637

(57) ABSTRACT

A advanced planning and scheduling (APS) application for processing business objectives in a process industry. A method of the APS uses a business priority provided by a user for each the business objectives, ranks the business priority for each of the business objectives from a top priority to a lowest priority, and identifies a set of desired solutions for the top priority business objective. The method selects solutions in the set of desired solutions whose percentage change in honoring a second highest priority business objective is more than a percentage change in the top priority business objective. The method iterates through the solutions in the set of desired solutions for each of the remaining business objectives to realize an output solution such that the business objectives are optimized through successive linear programming.

### TECHNICAL FIELD

This disclosure relates generally to enterprise optimization systems. More specifically, this disclosure relates to an apparatus and method for integrating planning, scheduling, and control for enterprise optimization.

### BACKGROUND

Processing facilities are often managed using a process control systems. Example processing facilities include manufacturing plants, chemical plants, crude oil refineries, and ore processing plants. Plant operations planned and scheduled are based on customer demands through a planning and scheduling application.

The planning and scheduling application needs to meet various objectives of the plant, for instance, meeting customer demand, minimizing production cost, maximizing equipment utilization in the process plant, etc. There are a trade-offs between these objectives. A process control planning and scheduling application captures user defined trade-offs through numerical parameter/weightage where implications are not clearly known to the end user, and the user cannot clearly understand the effect of parameters on solution behavior. Hence, the user is forced to run the application multiple times with different parameter combinations in an effort to get a desired or expected solution.

Most of the planning and scheduling problems have more than one objective with different units of measure (e.g. cost and efficiency) and different scale. In most cases, the customer clearly knows the defined order of priority of each objective based on their business and operational practice. Traditionally, solution vendors transform the customer business needs into a single objective function (e.g. cost), which when solved can lead to pareto-optimal solutions.

The difficulty in identifying the costs associated with each operation limits the use of cost as a based objective. Traditional solutions are built around variable costs, resulting in inefficient utilization of fixed costs assets (in terms of ROI on the particular equipment). It is difficult to incorporate business compulsions even though it is not cost effective (e.g. strategic orders, which may be beneficial in the long term). Hence, a transformed objective can lead to impractical solutions. A degree of freedom is limited in a single objective optimization, which may or may not be practical to use.

The end user is often forced to disclose their business and operational practices to the solution vendors so that solution vendors can add appropriate weightage for each objective. Further, organizations depend on specialized skills to use existing systems, hence, it is difficult to get the right people to substitute. Also, the time needed to arrive at a practical solution manually impacts decision making, resulting in potential losses.

### SUMMARY

This disclosure provides an analytic framework for handling trade-offs between different business objectives in planning and scheduling applications.

In one example embodiment, a method of processing business objectives in a planning and scheduling system is provided. The method includes using a plurality of business objectives provided by a user for a process control system configured to determine how to meet a customer demand with available resources in the process control system. The method also includes ranking a business priority provided by a user for each of the business objectives from a top priority to a lowest priority, and identifying a set of desired solutions for the top priority business objective. The method further includes selecting solutions in the set of desired solutions whose percentage change in honoring a second highest priority business objective is more than a percentage change in the top priority business objective. The method still further includes selecting solutions in the set of desired solutions whose percentage change in honoring a next highest priority business objective is more than the percentage change in the second highest priority business objective. The method also includes iterating through the solutions in the set of desired solutions for each of the remaining business objectives, and realizing an output solution such that the business objectives are optimized through successive linear programming.

In some embodiments, if two of the business Objectives have the same priority, the method solves each of the business objectives with the same priority before solving the next highest priority business objective. Resultants from solving each of the business objectives with the same priority may be set as an upper bound or a lower bound for the business objective solved. One of the business objectives may be changed with reference to an individual resultant solution, and may be solved for minimizing a percentage deviation. The resultant solution may be used as a target from the same priority objective for subsequent iterations. A lowest solution in the set of desired solutions may be a predetermined function of a highest solution in the set of desired solutions, such as it may be 50% of the highest solution.

In another embodiment, a system for processing business objectives in a process control system includes at least one controller. The at least one controller is configured to use a plurality of business objectives provided by a user for a process control system to determine how to meet a customer demand with available resources in the process control system. The at least one controller is configured to identify a business priority of each the business objectives, rank the business priority for each of the business objectives from atop priority to a lowest priority, and identify a set of desired solutions for the top priority business objective. The at least one controller is configured to select solutions in the set of desired solutions whose percentage change in honoring a second highest priority business objective is more than a percentage change in the top priority business objective. The at least one controller is configured to select solutions in the set of desired solutions whose percentage change in honoring a next highest priority business objective is more than the percentage change in the second highest priority business objective. The at least one controller is configured to iterate through the solutions in the set of desired solutions for each of the remaining business objectives, and realize an output solution such that the business objectives are optimized through successive linear programming.

In some embodiments, the at least one controller is configured to, if two of the business objectives have the same priority, solve each of the business objectives with the same priority before solving the next highest business priority business objective. Resultants from solving each of the business objectives with the same priority may be set as an upper bound or a lower bound for the business objective solved. One of the business objectives may be changed with reference to an individual resultant solution, and may be solved for minimizing a percentage deviation. The resultant solution may be used as a target from the same priority objective for subsequent iterations. A bound for one of the business objectives may be limited by user defined values or percentages. A lowest priority solution in the set of desired solutions may be a predetermined function of a highest solution in the set of desired solutions.

In another embodiment, a non-transitory computer readable medium encoded with a computer program comprises computer readable program code for identifying a plurality of business objectives for a process control system configured to determine how to meet a customer demand with available resources in the process control system. The code is also for using a business priority provided by a user for each the business objectives, ranking the business priority for each of the business objectives from a top priority to a lowest priority, and identifying a set of desired solutions for the top priority business objective. The code is further for selecting solutions in the set of desired solutions whose percentage change in honoring a second highest priority business objective is more than a percentage change in the top priority business objective. The code is still further for selecting solutions in the set of desired solutions whose percentage change in honoring a next highest priority business objective is more than the percentage change in the second highest priority business objective. The code is also for iterating through the solutions in the set of desired solutions for each of the remaining business objectives, and realizing an output solution such that the business objectives are optimized through successive linear programming.

In some embodiments, the code is for solving, if two of the business objectives have the same priority, each of the business objectives with the same priority before solving the next highest business priority business objective. Resultants from solving each of the business objectives with the same priority may be set as an upper bound or a lower bound for the business objective solved. One of the business objectives may be changed with reference to an individual resultant solution, and may be solved for minimizing a percentage deviation. The resultant solution may be used as a target from the same priority objective for subsequent iterations. A bound for one of the business objectives may be limited by user defined values or percentages. A lowest solution in the set of desired solutions may be a predetermined function of a highest solution in the set of desired solutions.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to this disclosure;

FIG. 2 illustrates parameters utilized and addressed by an advanced planning and scheduling (APS) according to this disclosure;

FIGS. 3A and 3B (collectively “FIG. 3”) illustrate an example method of the APS according to this disclosure; and

FIG. 4 illustrates an example process of handling trade-offs between different business objectives in application to the paper industry according to this disclosure.

### DETAILED DESCRIPTION

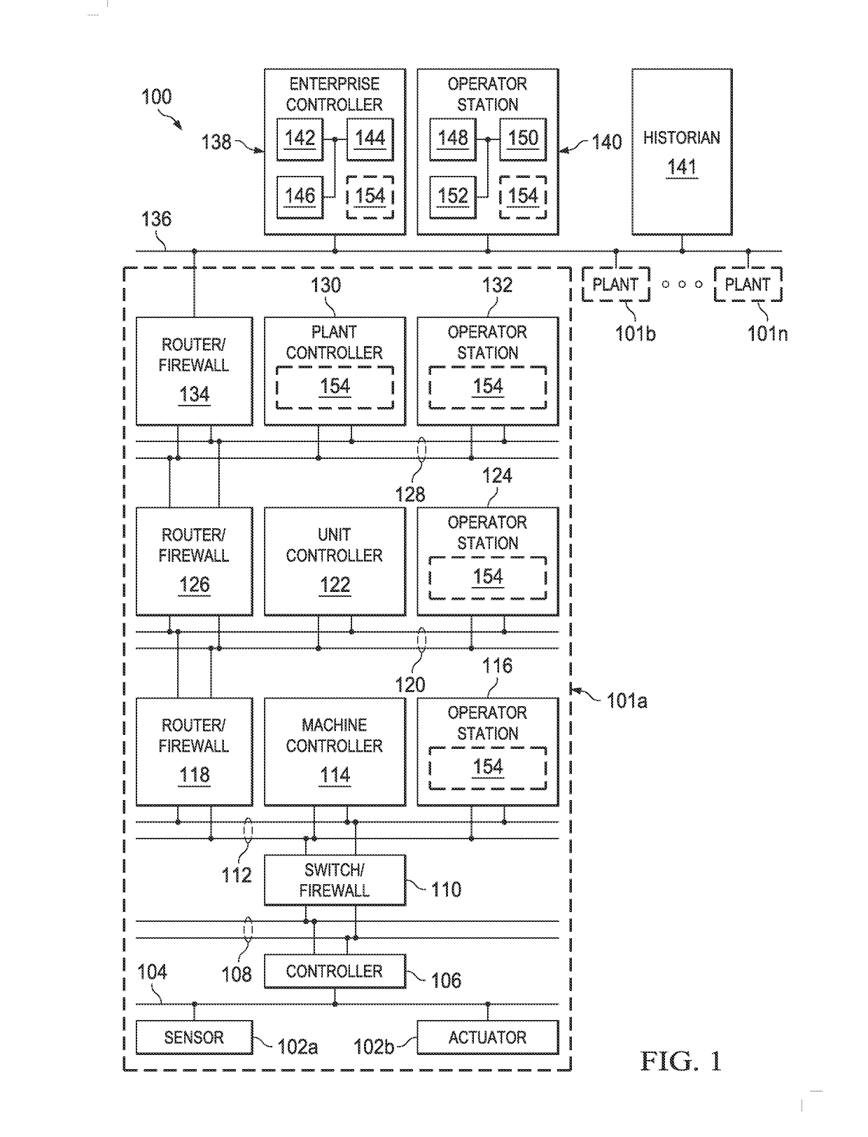

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example process control system 100 according to this disclosure. The embodiment of the process control system 100 shown in FIG. 1 is for illustration only. Other embodiments of the process control system 100 may be used without departing from the scope of this disclosure.

In this example embodiment, the process control system 100 includes various components that facilitate production or processing of at least one product or other material. For instance, the process control system 100 is used here to facilitate control over components in one or multiple plants 101a-101n. Each plant 101a-101n represents one or more processing facilities (or portions thereof), such as one or more manufacturing facilities for producing at least one product or other material. In general, each plant 101a-101n may implement one or more processes and can individually or collectively be referred to as a process system. A process system may generally represent any system or portion thereof configured to process one or more products or other materials in some manner.

In FIG. 1, the process control system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b, such as heaters, motors, or valves, could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any hardware, software, firmware, or combination thereof for interacting with one or more sensors 102a and controlling one or more actuators 102b. Each controller 106 could, for example, represent a multivariable controller, such as a Robust Multivariable Predictive Control Technology (RMPCT) controller or other type of controller implementing advanced process control (APC). As a particular example, each controller 106 could represent a computing device running a MICROSOFT WINDOWS operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any hardware, software, firmware, or combination thereof for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any hardware, software, firmware, or combination thereof for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any hardware, software, firmware, or combination thereof for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any hardware, software, firmware, or combination thereof for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controllers 130 could execute one or more manufacturing execution system (MES) applications, scheduling applications, or other or additional plant or process control applications. Each of the plant-level controllers 130 includes any hardware, software, firmware, or combination thereof for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any hardware, software, firmware, or combination thereof for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. Each network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controllers 138 could execute one or more order processing applications, enterprise resource planning (ERP) applications, advanced planning and scheduling (APS) applications, or any other or additional enterprise control applications. Each of the enterprise-level controllers 138 includes any hardware, software, firmware, or combination thereof for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any hardware, software, firmware, or combination thereof for supporting user access and control of one or more components in the system 100. Each of the operator stations 140 could, for example, represent a computing device running a MICROSOFT WINDOWS operating system.

A historian 141 is also coupled to the network 136 in this example. The historian 141 could represent a component that stores various information about the process control system 100. The historian 141 could, for example, store information used during production scheduling and optimization. The historian 141 represents any suitable component for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processors 142 and one or more memories 144 for storing instructions and data used, generated, or collected by the processor(s) 142. Each of the servers could also include at least one network interface 146, such as one or more Ethernet interfaces. Also, each of the operator stations could include one or more processors 148 and one or more memories 150 for storing instructions and data used, generated, or collected by the processor(s) 148. Each of the operator stations could also include at least one network interface 152, such as one or more Ethernet interfaces.

As described above, different components in the process control system 100 may use different types of models. For example, one or more of the controllers 106, 114, and 122 could implement advanced process control functions using detailed dynamic models. One or more of the controllers 130 and 138 could implement planning and production scheduling functions using aggregate models.

In one aspect of operation, at least one component of the system 100 implements or otherwise provides an integration mechanism that helps to integrate multiple components of the process control system 100. For example, advanced process control components can perform their functions using the detailed dynamic models, and planning and production scheduling components can perform their functions using the aggregate models. The integration mechanism allows different components with distinctly different models to collaborate and optimize together by using “contribution values” and “predicted yields,” which are described below.

The integration mechanism can be implemented as an integration unit 154 in one or more components of the process control system 100. For example, the integration unit 154 could be implemented on the operator station 116, operator station 124, plant-level controller 130, operator station 132, enterprise-level controller 138, or operator station 140. In general, the integration unit 154 could be implemented on any server, real-time workstation, application or execution platform, distributed control system (DCS), real-time controller, or other suitable device or system.

In some embodiments, the integration unit 154 is used to integrate planning and scheduling tools with APC/unit optimization tools. The integration unit 154 could be implemented as a software package executed as a real-time plant-wide optimizer that coordinates productions, handles upsets, compensates for model-versus-actual mismatches, minimizes feed and utility use, captures market opportunities, and maximizes plant profitability in real-time.

As noted above, the integration unit 154 can support the use of contribution values. Each contribution value may be associated with an intermediate product that is used to produce one or more final products (a final product represents a product output by the process system). A contribution value may be computed using that intermediate product's contribution to each final product and each final product's price. The integration unit 154 can also support the use of predicted yields, which represent estimates of the quantity of one or more intermediate or final products to be produced by the process system in a given time period. In an iterative process, the contribution values and the predicted yields can be revised by the integration unit 154 until an optimum point is found. This point may represent the optimal production schedule to be used, while taking into account both constraints and other limitations of the process system and business economics.

Additional details regarding the integration unit 154 and the use of contribution values and predicted yields are described below. The integration unit 154 includes any hardware, software, firmware, or combination thereof supporting the integration of multiple components using an intermediate product's contribution to one or more final products and each final product's price. The integration unit 154 could, for example, represent a computing device having at least one processor, at least one memory, and at least one network interface (note that the processor, memory, and network interface could be the same components in an operator station or controller or different components).

The integration mechanism allows various components in the system 100 to complete their designed functions while achieving dynamic global optimization. Depending on the implementation, benefits of this integration could include:
feed reduction of raw materials entering a process system while meeting production plans;
more economic operation for handling upsets in process units;
more agile response to capture spot market buy/sell opportunities;
reconciled feedback for next-period planning;
ability to re-use planning models (which are often multi-year projects involving millions of dollars);
reduction of total inventory (and thus capital) in the presence of demand fluctuations; and
movement of inventory upstream to make irreversible decisions just in time.
   Various ones of these benefits can be obtained in both process industries and discrete manufacturing industries.

Although FIG. 1 illustrates an example process control system 100, various changes may be made to FIG. 1. For example, a control system could include any number of sensors, actuators, controllers, servers, operator stations, networks, and integration units. Also, the makeup and arrangement of the process control system 100 in FIG. 1 is for illustration only. Components could be added, omitted, combined, or placed in any other suitable configuration according to particular needs. Further, particular functions have been described above as being performed by particular components of the system 100. This is for illustration only. In general, process control systems are highly configurable and can be configured in any suitable manner according to particular needs. In addition, FIG. 1 illustrates one operational environment in which an integration unit can be used. This functionality could be used in any other suitable device or system (whether or not related to process control).

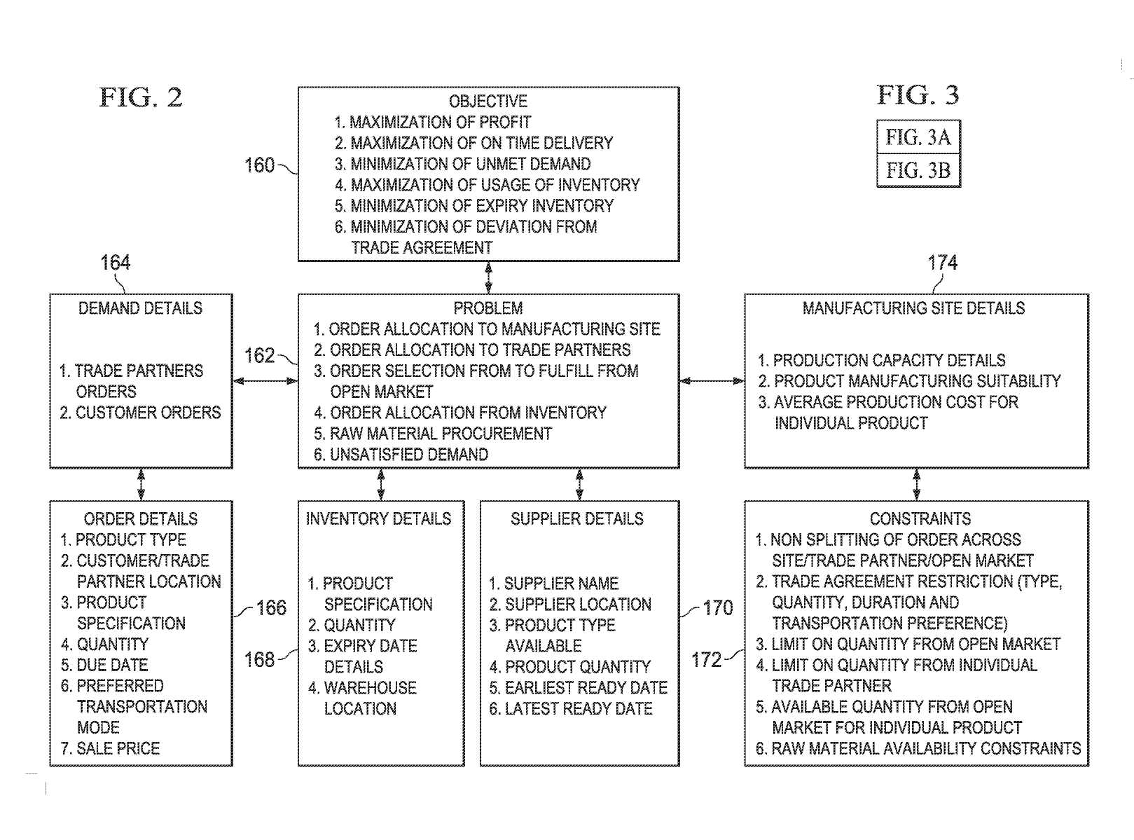

FIG. 2 illustrates parameters utilized and addressed by an advanced planning and scheduling (APS) application, system, and method of the present disclosure. An example list of business objectives is shown at 160. List 160 shows an order of business priority established by a user for each of the business objectives from a highest priority to a lowest priority. Other lists, and different orders of business priorities may be established, and limitation to this example embodiment is not to be inferred. A listing of problems addressable by the APS is shown at 162. Demand details are shown at 164, order details are shown at 166, inventory details are shown at 168, and supplier details are shown at 170. Constraints on the APS are shown at 172, and manufacturing site details are shown at 174.

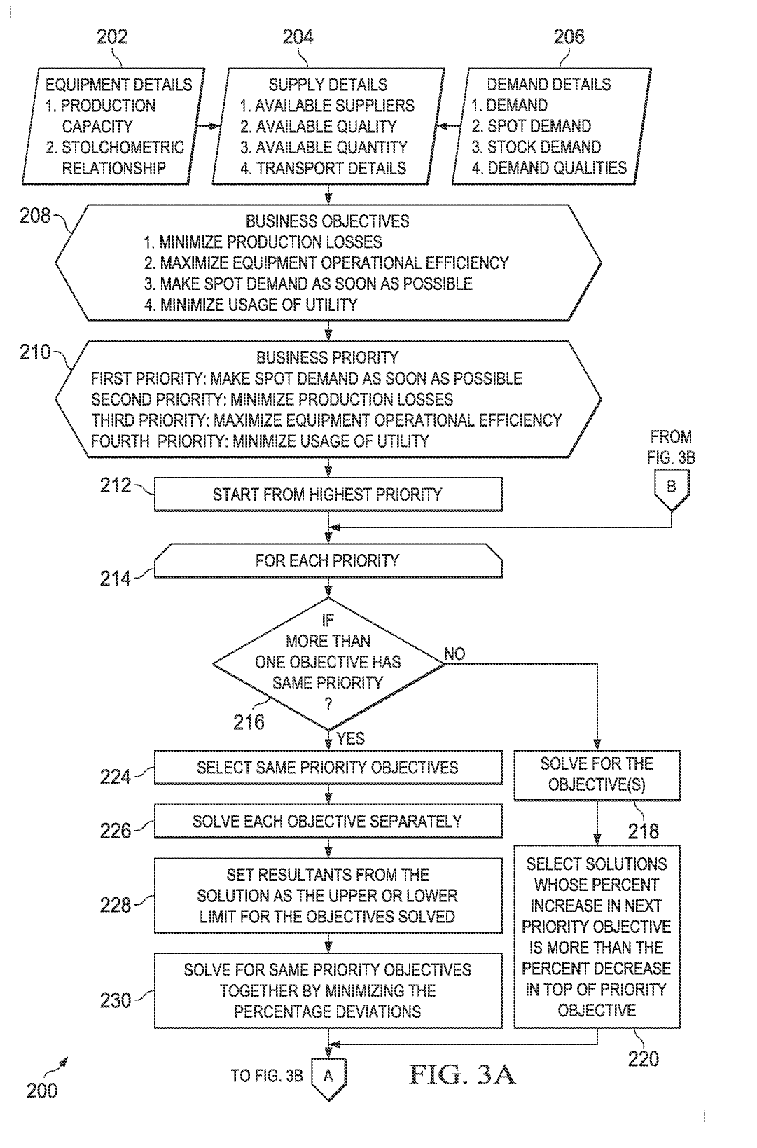

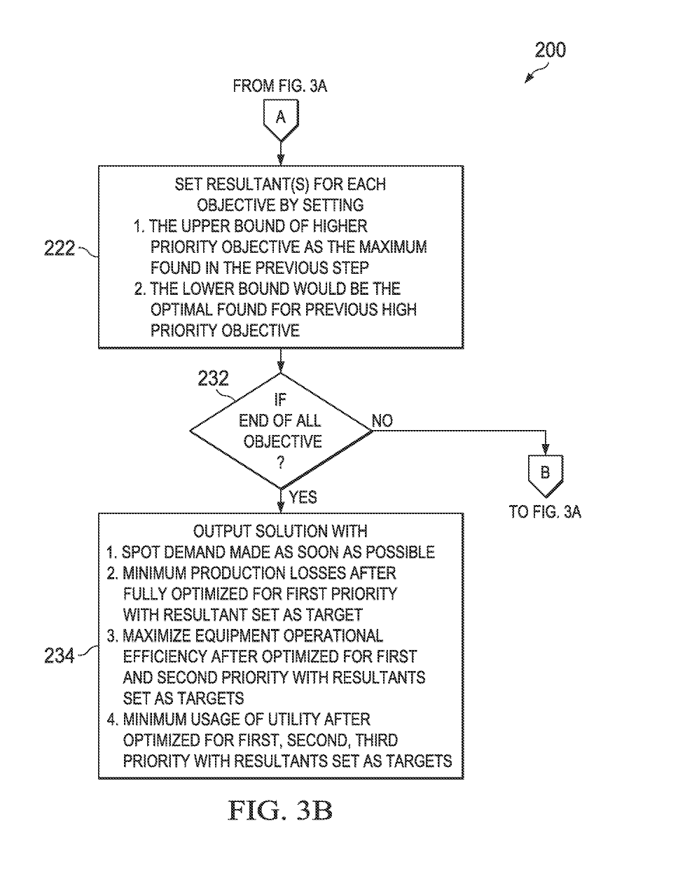

FIGS. 3A and 3B illustrate an example method of the advanced planning and scheduling (APS) application according to this disclosure. In some embodiments, the method 200 of the APS application may be executable by the enterprise-level controller 138 of FIG. 1. The APS application is suitable for planning and scheduling applications at the corporate/enterprise/production unit level to optimize plant operations, minimize raw material costs, and honor delivery dates to customers. The example method 200 of the APS application shown in FIGS. 3A and 3B is for illustration only. Other embodiments of the method 200 may be used without departing from the scope of this disclosure.

In this example, the APS application provides user priority driven successive linear optimization. A non-linear complex relation between objectives is solved successively, wherein the sequence in which the problem is solved is decided by a user's defined priority. The problems are solved at multiple levels by dynamically adding objective terms.

The method 200 shown in FIGS. 3A and 3B is operable by the controller 138. At step 202, the controller 138 initially determines the equipment details of all equipment in the process control system 100. This includes the production capacity of each piece of equipment and other operational parameters, such as performance limits. The controller 138 also determines the stoichiometric relationships of the equipment.

At step 204, the controller 138 determines supply details, including available suppliers, and available quality and available quantities of each supply available to or utilized by the process control system 100, categorized for each supplier. The controller 138 also obtains transport details of the respective supplies for each supplier.

At step 206, the controller 138 determines demand details of the supplies, including spot demand, stock demand, and demand qualities. The demand may be calculated on a per supplier basis, as well as on an industry wide basis.

At step 208, a user determines business objectives for the system 100, which business objectives are selected from a predetermined list of business objectives stored in a memory, such as the memory 144. The business objectives are identified in no particular order, and are quantifiable objectives configured to be solved by the controller 138. For instance, by way of illustration but without limitation thereto, the business objectives may be to minimize production losses, maximize equipment operational efficiency, make spot demand as soon as possible (ASAP), and minimize usage of a utility. Many other business objectives may be identified, and limitation to only four business objectives is not to be inferred.

At step 210, the user then identifies the business priority of each business objective identified in step 208. The user numerically ranks each business objective from the highest, priority to the lowest priority. For example, based on the business objectives identified in step 208, the highest priority business objective may be to make spot demand ASAP, the next highest priority business objective may be to minimize production losses, followed by maximizing equipment operational efficiency, and the lowest priority business objective may be minimize usage of utility.

At step 212, the controller 138 processes the business objectives identified in step 210, and starts by processing the highest priority business objective.

At step 214, for each identified business objective of step 210, the controller 138 determines at step 216 if more than one business objective has the same business priority as the identified business objective. If the determination is no, the controller 138 proceeds to step 218 and step 220 to solve the identified business objective. The controller 138 parses a set of available solutions stored in the memory 144 for the identified business objective, and identifies a set of desired solutions for that business objective, such as identifying the top ten solutions from the set of available solutions. The set of desired solutions is determined by the controller 138 by a process, such as by identifying the top solution and the minimum solution to be included in the set of desired solutions. For example, the top solution in the set of desired solutions may be a multiple of the lowest solution in the set of desired solutions, such as 2×. The objective is to find the lowest solution to be included in the set of desired solutions for the business objective addressed.

At step 220, the controller 138 iterates through the solutions from the set of desired solutions for the identified business objective, and selects all the solutions in the set of desired solutions whose percentage increase in honoring the next priority business objective is more than the percentage decrease in the top priority business objective. In this way, for each solution considered for the business objective being addressed, the controller 138 considers the effect of the solution on other business objectives.

The controller 138 then proceeds to step 222 and sets one or more resultants for each objective.

Considering that the objective is to minimize the negative effects on other business objectives while solving each business objective, the problem with the next business objective priority is solved with the resultant from the previous solution for subsequent iterations. This is done by setting the upper bound of the higher priority objective as the maximum found in the previous step, and setting the lower bound as optimal found for the previous high priority objective.

At step 232, if the controller 138 determines there is another priority business objective to be solved, the method 200 iterates through steps 214, 216, 218, 220 and 222 for each business objective, in the order of priority established in step 210. If there are no other priority business objectives to be solved, the method proceeds to step 234.

If more than one business objective is determined to have the same priority in step 216, the same priority business objectives are selected at step 224. The controller 138 solves each of the business objectives individually at step 226.

At step 228, the resultants from the solution are set as the upper bound or lower bound for the business objective solved.

At step 230, the objective is changed with reference to the individual resultant solution, and is solved for minimizing a percentage deviation.

At step 222, the resultant is used as the target from the same priority objective for subsequent iterations. The bound for the business objectives could also be limited by user defined values or percentages.

When all priority business objectives are determined to have been optimized at step 232, an output solution is realized at step 234, such that the priority business objectives were optimized through the successive linear programming. In this example, the first priority business objective is optimized, the second priority business objective is optimized after optimizing the first priority business objective, the third priority business objective is optimized after optimizing the first and second priority business objectives, and the fourth priority business objective is optimized after optimizing the first, second and third priority business objectives.

Although FIGS. 3A and 3B illustrate one example of a method 200 of an APS application, various changes may be made to FIGS. 3A and 3B. For example, while shown as a series of steps, various steps shown in FIGS. 3A and 3B could overlap, occur in parallel, or occur multiple times. Moreover, some steps could be combined or removed and additional steps could be added

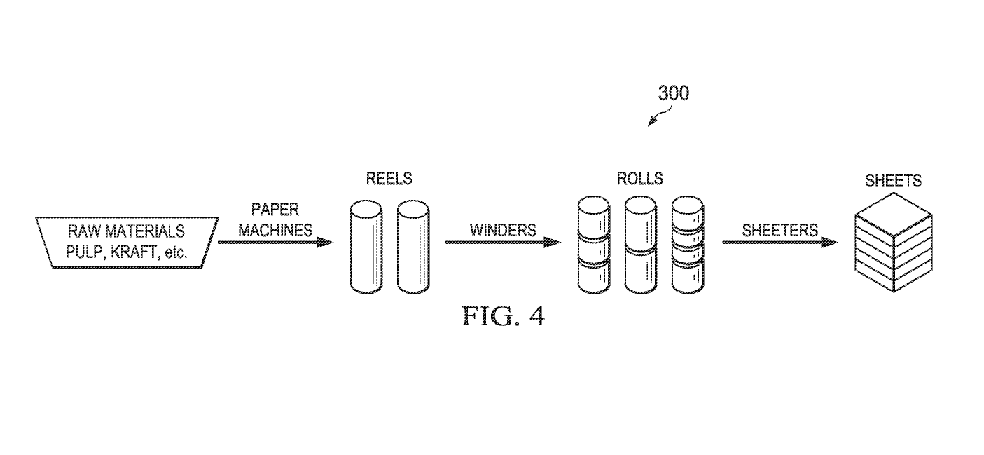

FIG. 4 illustrates an example process of handling trade-offs between different business objectives in application to the paper industry according to this disclosure. The embodiment of the process 300 shown in FIG. 4 is for illustration only. Other embodiments may be used without departing from the scope of this disclosure.

The paper industry manufactures many kinds of paper to satisfy the diverse needs of printing and packaging. Paper production consists of several stages, which may vary depending on the kind of paper being produced, but the overall process is generally similar to that shown in FIG. 4. The first step in paper manufacturing is the production of pulp from logs, wood chips, recycled paper, and other sources of fiber. The pulp is fed into a paper machine along with other ingredients that make up the “recipe” for a particular grade and basis weight of paper, that is, a product. The grade of paper is determined by physical and optical characteristics, such as smoothness, oil absorbency, gloss, and shade. The basis weight is the weight of a specified area of paper or paperboard. A paper machine produces large reels of paper. The width of the reel, called the deckle, is fixed for each machine. Another machine called a winder unwinds the reel while slicing it into narrower strips which it then rewinds to form rolls. The process of cutting a reel to make rolls is called trimming and the portion of the deckle that is not consumed by the rolls is the trim loss. The arrangement of the slitting knives on the winder constitutes a trim pattern. Typically, several rolls are made from each reel. The widths and diameters of these rolls must match the customer requirements. Detailed plans, which include the selection of patterns and, their sequencing, for cutting a set of large reels of paper into smaller rolls are called, trim sheets. As the rolls are produced, they are wrapped for shipping or temporary storage. In case of cut-sheet paper products, the rolls are loaded onto a sheeter, which unwinds the roll and slices the paper into sheets of the desired size. The sheets are then wrapped and packaged for shipping. Finally, the end products are loaded on to trucks and rail cars for shipment to customers, warehouses, and ports.

Most paper manufacturers produce to order because the large number of combinations of product type and roll size makes it impractical to stock enough inventory. Each customer order specifies a quantity (in tons or number of rolls), a product type, roll dimensions (width and diameter), due date, and shipping destination. While customers prefer to have their orders filled exactly, there is typically a standard tolerance, for example, plus or minus three percent, on the quantity that can be produced to satisfy an order. To improve efficiency, manufacturers sometimes take advantage of this tolerance and produce more or less than the ordered amount. The amount produced in excess of the order quantity is called overrun. Similarly, any production shortfall is called under-run. The paper manufacturer is usually responsible for the freight cost from its mill to the customer's location, which can constitute as much as 15 percent of the selling price. Each paper machine is capable of producing a subset of the company's products at different production rates. Paper production is a continuous process in which a machine can make only one product at a time because each product has its own unique recipe. When a machine switches from one product to another, it continues to operate, but the paper it produces may be of inferior quality for some time after the change is initiated. The length of this transition time or setup time depends on the products being produced before and after the transition; transitions between similar products are shorter than transitions between dissimilar products. That is, the setup times are sequence dependent. The setup times between products can also be machine dependent. The production between two consecutive setups is called a run.

Planning and scheduling of paper manufacturing typically respond to customer demands for various grades of products in a competitive manner. Customer demands for paper products can be classified into two definite orders: firm orders and speculative orders (sometimes referred to as tentative or forecasted orders). Given a set of firm and speculative orders for a paper manufacturing plant over a time horizon, orders are allocated and sequenced on machines by simultaneously taking into consideration many business/production objectives, such as:

production cost, (in terms of dollars)

transportation cost (in terms of dollars);

due dates;

inventory cost (in terms of dollars, but when compared to production cost, this can be insignificant);

available inventory for finished products or raw material (in terms of quantity, e.g., tons);

trim loss (in terms of quantity, e.g., tons, or in terms of percentage loss at the machine, e.g., quantity of waste/quantity produced);

set up time (e.g., change over times between grades, in terms of hours); or

throughput for units (e.g., paper machine, sheeter, and rewinder, in terms of tons per day processed or percentage of machine utilization, e.g., total quantity processed/maximum capacity of the machine).

From the description above, it is clear that there are multiple objectives and each one may have a different unit of measure or different scale. Depending on the business needs and operational practices, management can have clear priority among the above objectives. Even within the same units of measure, for example, production rates at the winder machine could be at a higher priority than production rates at the rewinder machines. The production rates of sheeter could be a highest priority. Hence, the planning and scheduling solution may have to consider the user defined priority.

For simplicity, consider two objectives of different priority:

The first objective is minimization of trim loss.

The second objective is maximization of sheeter throughput.

Scenario 1: Priorities are Different

First, the priority for each objective is clearly defined. Assuming that the priority for the minimization of trim loss is higher than the maximization of sheeter throughput, according to this disclosure, the first step solves for minimization of trim loss only. The second step then solves for maximization of sheeter throughput with the value found for the trim loss as the upper bound.

At this point, the solution is optimized for trim loss, and sheeter throughput is optimized within the bounds for trim loss.

Scenario 2: Priorities are Different with a Compromise

There is also a possibility to accept a slightly higher trim loss to achieve a significant gain on sheeter productivity.

This is illustrated through the calculations in Table 1 below. Upon solving for minimization of trim loss, the top 10 solutions are found (if 10 exist). From these solutions, the sheeter productivity is calculated for each of them, whose results are given in the second column. The third column shows the percentage variation of trim loss with respect to the best trim loss solution (in Table 1, the first has the best trim loss, which in this case, the value is 3.07). The fourth column is the percentage gain in sheeter productivity with respect to best trim loss solutions sheeter productivity (in this case, the value is 40). The fifth column shows the percentage sheeter productivity increase with respect to the percentage trim loss compromised. A very small change in trim loss is realized (0.97 percent), however, the sheeter productivity has increased by 1391 percent, which is very significant. Hence, it could be very appropriate to relax the upper bound on the trim loss to 3.1 instead of 3.07 while solving for sheeter productivity.

TABLE 1

| | | | Trim loss | Sheeter | (sheeter productivity gain − |
|---|---|---|---|---|---|
| | | Percentage | percentage | productivity | trim loss percentage |
| Solution | trim loss | sheeter | compromised | gain | compromised)*100/trim loss |
| no | in tons | productivity | (in percentage) | (in percentage) | percentage compromised |
| 1 | 3.07 | 40.00 | | | |
| 2 | 3.10 | 45.83 | 0.98 | 14.58 | 1391.51 |
| 3 | 3.11 | 41.85 | 1.30 | 4.63 | 254.97 |
| 4 | 3.12 | 45.64 | 1.63 | 14.10 | 765.74 |
| 5 | 3.14 | 52.29 | 2.28 | 30.73 | 1247.51 |
| 6 | 3.15 | 45.57 | 2.61 | 13.93 | 434.37 |
| 7 | 3.16 | 52.46 | 2.93 | 31.15 | 962.56 |
| 8 | 3.16 | 41.19 | 2.93 | 2.97 | 1.48 |
| 9 | 3.20 | 45.77 | 4.23 | 14.43 | 240.65 |
| 10 | 3.30 | 37.30 | 7.49 | −6.75 | −190.10 |

Scenario 3: Priorities are Equal

Now, a scenario is considered where both the objectives have been given the same priority. A process is applied as follows.

First step, solve for minimization of trim loss and maximization of throughput separately.

Second step, set the trim loss found while solving for sheeter productivity as the upper bound, and set sheeter productivity found while solving for trim loss minimization as the lower bound. The objective is defined to minimize the percentage deviation from the best trim loss found and best sheeter throughput found.

Third step, solve for the objective and bounds defined in step two.

From Table 1, in the first step, it is determined to consider the solutions 1 and 7. The second step sets the upper bound for trim loss to 3.16 and the lower bound for sheeter productivity to 40.

The objective can be represented by the following:

minimize{[trim_loss−Trim_loss_best (3.07)]/Trim_loss_best

+

([Sheeter_productivity_best(52.46)−sheeter_productivity]/Sheeter_productivity_best)

Additional Constrains (Bounds)
trim_loss<=3.16
sheeter_productivity>=40

TABLE 2

| | | | | sheeter | |
|---|---|---|---|---|---|
| | | Percentage | trim loss | throughput | |
| Solution | Percentage | sheeter | deviation | deviation | objec- |
| no | trim loss | poductivity | (percentage) | (percentage) | tive |
| 1 | 3.07 | 40.00 | 0.00 | 23.75 | 23.75 |
| 2 | 3.10 | 45.83 | 0.98 | 12.64 | 13.62 |
| 3 | 3.11 | 41.85 | 1.30 | 20.22 | 21.53 |
| 4 | 3.12 | 45.64 | 1.63 | 13.00 | 14.63 |
| 5 | 3.14 | 52.29 | 2.28 | 0.32 | 2.60 |
| 6 | 3.15 | 45.57 | 2.61 | 13.13 | 15.74 |
| 7 | 3.16 | 52.46 | 2.93 | 0.00 | 2.93 |
| 8 | 3.16 | 41.19 | 2.93 | 21.48 | 24.41 |
| 9 | 3.20 | 45.77 | 4.23 | 12.75 | 16.99 |
| 10 | 3.30 | 37.30 | 7.49 | 28.90 | 36.39 |

Table 2 is the same example with the calculation for the objective which shows solution 5 is the best when both priorities are equal.

The illustrations described above provide a very simple example to enable easier understanding. This described approach is generic, and can be:

Scalable (the approach can solve problems from production management to enterprise level solutions).

Extendable (it can be applied across multiple industries like refining, power generation, etc.).

Modular (it helps to provide a plug and play approach to solving problems).

Advantageously, embodiments of this disclosure provide a user intuitive configuration setting that makes the user relate their needs to the solution, and is an effective way of handling a customer's overall needs. This disclosure provides an overall superior solution in terms of practicality of usage, resource utilization and cost minimization. The configuration is easy; for example, the customer provides its priority. The intuitive configuration reduces engineering and training costs, and is practical, as it makes the planner accept the solution as it is against making modifications to incorporate practical needs, i.e., it reduces the person dependency. Further, it is easy to add new functionality due to the modular solution approach.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of electronically processing business objectives in a planning and scheduling system, the method comprising:
identifying a plurality of business objectives to determine how to meet a customer demand with available resources in a process control system;
ranking a business priority provided by a user for each of the business objectives from a top priority to a lowest priority;
identifying a set of desired solutions for the top priority business objective;
selecting solutions in the set of desired solutions whose percentage change in honoring a second highest priority business objective is more than a percentage change in the top priority business objective;
selecting solutions in the set of desired solutions whose percentage change in honoring a next highest priority business objective is more than the percentage change in the second highest priority business objective;
iterating through the solutions in the set of desired solutions for each of the remaining business objectives; and
realizing an output solution such that the business objectives are optimized through successive linear programming.

2. The method as specified in claim 1, further comprising:
if two of the business objectives have the same priority, solving each of the business objectives with the same priority before solving the next highest business priority business objective.

3. The method as specified in claim 2, wherein resultants from solving each of the business objectives with the same priority are set as an upper bound or a lower bound for the business objective solved.

4. The method as specified in claim 3, wherein one of the business objectives is changed with reference to an individual resultant solution, and is solved for minimizing a percentage deviation.

5. The method as specified in claim 4, wherein the resultant solution is used as a target from the same priority objective for subsequent iterations.

6. The method as specified in claim 4, wherein a bound for one of the business objectives is limited by user defined values or percentages, or the resultant solution.

7. The method as specified in claim 1, wherein a lowest solution in the set of desired solutions is a predetermined function of a highest solution in the set of desired solutions.

8. A system for processing business objectives in a planning and scheduling system, the system comprising:
at least one controller configured to:
identify a plurality of business objectives to determine how to meet a customer demand with available resources in the process control system;
rank a business priority provided by a user for each of the business objectives from a top priority to a lowest priority;
identify a set of desired solutions for the top priority business objective;
select solutions in the set of desired solutions whose percentage change in honoring a second highest priority business objective is more than a percentage change in the top priority business objective;
select solutions in the set of desired solutions whose percentage change in honoring a next highest priority business objective is more than the percentage change in the second highest priority business objective;
iterate through the solutions in the set of desired solutions for each of the remaining business objectives; and
realize an output solution such that the business objectives are optimized through successive linear programming.

9. The system as specified in claim 8, wherein the at least one controller is configured to, if two of the business objectives have the same priority, solve each of the business objectives with the same priority before solving the next highest business priority business objective.

10. The system as specified in claim 9, wherein resultants from solving each of the business objectives with the same priority are set as an upper bound or a lower bound for the business objective solved.

11. The system as specified in claim 10, wherein one of the business objectives is changed with reference to an individual resultant solution, and is solved for minimizing a percentage deviation.

12. The controller as specified in claim 11, wherein the resultant solution is used as a target from the same priority objective for subsequent iterations.

13. The system as specified in claim 11, wherein a bound for one of the business objectives is limited by user defined values or percentages, or the individual resultant solution.

14. The system as specified in claim 8, wherein a lowest solution in the set of desired solutions is a predetermined function of a highest solution in the set of desired solutions.

15. A non-transitory computer readable medium encoded with a computer program, the computer program comprising computer readable program code for:
identifying a plurality of business objectives to meet a customer demand with available resources in a process control system;
ranking a business priority provided by a user for each of the business objectives from a top priority to a lowest priority;
identifying a set of desired solutions for the top priority business objective;
selecting solutions in the set of desired solutions whose percentage change in honoring a second highest priority business objective is more than a percentage change in the top priority business objective;
selecting solutions in the set of desired solutions whose percentage increase in honoring a next highest priority business objective is more than the percentage decrease in the second highest priority business objective;
iterating through the solutions in the set of desired solutions for each of the remaining business objectives; and
realizing an output solution such that the business objectives are optimized through successive linear programming.

16. The computer readable medium as specified in claim 15, wherein the computer program further comprises computer readable program code for:
if two of the business objectives have the same priority, solving each of the business objectives with the same priority before solving the next highest business priority business objective.

17. The computer readable medium as specified in claim 16, wherein resultants from solving each of the business objectives with the same priority are set as an upper bound or a lower bound for the business objective solved.

18. The computer readable medium as specified in claim 17, wherein one of the business objectives is changed with reference to an individual resultant solution, and is solved for minimizing a percentage deviation.

19. The computer readable medium as specified in claim 18, wherein the resultant solution is used as a target from the same priority objective for subsequent iterations.

20. The computer readable medium as specified in claim 18, wherein a bound for one of the business objectives is limited by user defined values or percentages.

21. The computer readable medium as specified in claim 15, wherein a lowest solution in the set of desired solutions is a predetermined function of a highest solution in the set of desired solutions.
